(19) United States
(12) Patent Application Publication
(10) Pub. No.: US 2023/0182084 A1
(43) Pub. Date: Jun. 15, 2023

(54) COMPOSITE REVERSE OSMOSIS MEMBRANE AND PRODUCTION METHOD THEREOF

(71) Applicant: NITTO DENKO CORPORATION, Osaka (JP)

(72) Inventors: Toshiyuki KAWASHIMA, Osaka (JP); Shunsuke NOMI, Osaka (JP); Tomotsugu MIYABE, Osaka (JP); Yunxia HU, Tianjin (CN); Shaolu LI, Tianjin (CN); Juntao WANG, Tianjin (CN); Yaxu GUAN, Tianjin (CN); Genghao GONG, Tianjin (CN); Yiwen QIN, Tianjin (CN)

(73) Assignee: NITTO DENKO CORPORATION, Osaka (JP)

(21) Appl. No.: 17/974,875

(22) Filed: Oct. 27, 2022

(30) Foreign Application Priority Data
Dec. 14, 2021 (CN) 202111527546.9

(51) Int. Cl. B01D 67/00; B01D 61/02; B01D 71/56; B01D 69/12

(52) U.S. Cl. CPC B01D 67/00931; B01D 61/02; B01D 71/56; B01D 69/125

(57) ABSTRACT

An object of the present invention is to provide a composite reverse osmosis membrane having improved water permeability and antifouling performance, and a method for producing the same. The composite reverse osmosis membrane of the present invention includes: a porous support; and a skin layer formed on a surface of the porous support. The skin layer contains a polyamide resin. The polyamide resin is a modified polyamide resin modified with an alkylenediamine derivative.

### BACKGROUND OF THE INVENTION

### Field of the Invention

The present invention relates to a composite reverse osmosis membrane including a skin layer and a porous support that supports the skin layer, and a production method thereof. The composite reverse osmosis membrane is suitable for production of ultrapure water, and desalination of brine or sea water, and the like, and can remove and recover pollution sources or effective substances from contamination or the like which causes pollution such as dyeing wastewater or electrodeposition coating material wastewater to contribute to closing of the wastewater. The composite reverse osmosis membrane can be used for advanced treatments such as concentration of active ingredients in food applications and the like, and removal of harmful ingredients in water purification and sewage applications and the like. The composite reverse osmosis membrane can be used for wastewater treatment in oil fields and shale gas fields and the like.

### Description of the Related Art

In a water treatment step using a composite reverse osmosis membrane, a phenomenon in which water permeation characteristics such as a water permeation amount and a salt-rejection rate decrease with the lapse of time, that is, fouling occurs. The largest cost among operation costs of water treatment facilities is used for loss treatment caused by the fouling and prevention of fouling. For this reason, fundamental prevention measures to such fouling have been required.

Causative substances that cause the fouling are classified into inorganic crystalline foulings, organic foulings, particles and colloidal foulings, and microbial foulings, based on the properties thereof. In the case of a polyamide-based composite reverse osmosis membrane, microbial fouling is a main causative substance, which is caused by the formation of a thin bio film with the absorption of microbes present in water to the surface of a separation membrane.

In order to reduce the fouling, methods such as pretreatment of raw water, modification of electrical property on the surface of a separation membrane, modification of a module step condition, and periodic cleaning have been widely used. In the case of foulings by microbes that are most frequently generated particularly in a composite reverse osmosis membrane, it is known that a treatment using disinfectants such as chlorine significantly decreases the microbial fouling. However, since the chlorine generates by-products such as carcinogenic substances, the application of the chlorine to a step for producing drinking water as it is causes many problems.

Recent research on an antifouling separation membrane focuses on change in the charge characteristics of the surface of the separation membrane. For example, a method for forming a surface layer containing a crosslinked organic polymer having a nonionic hydrophilic group on a reverse osmosis composite membrane has been proposed (Patent Document 1). A method for hydrophilically coating a polyamide thin membrane with a non-aqueous polymer obtained by crosslinking an epoxy compound has been proposed (Patent Document 2).

### PRIOR ART DOCUMENT

### Patent Document

Patent Document 1: JP-A-H11-226367
Patent Document 2: JP-A-2004-25102

### SUMMARY OF THE INVENTION

However, the methods of Patent Documents 1 and 2 have a low effect of suppressing deterioration in membrane characteristics due to biologically derived pollution or secondary pollution resulting therefrom, or the like. When a coating layer is separately provided on the surface of the separation membrane, the separation membrane has disadvantageously lowered water permeability.

An object of the present invention is to provide a composite reverse osmosis membrane having improved water permeability and antifouling performance, and a method for producing the same.

As a result of intensive studies to solve the problems, the present inventors found that the above object can be achieved by a composite reverse osmosis membrane shown below, and accomplished the present invention.

That is, the present invention relates to a composite reverse osmosis membrane including: a porous support; and a skin layer formed on a surface of the porous support, the skin layer containing a polyamide resin, wherein the polyamide resin is a modified polyamide resin modified with an alkylenediamine derivative.

The present invention also relates to a method for producing a composite reverse osmosis membrane, the method including the steps of: bringing an aqueous solution containing a polyfunctional amine component into contact with an organic solution containing a polyfunctional acid halide component on a porous support to form a skin layer containing a polyamide resin on a surface of the porous support; and bringing a solution containing an alkylenediamine derivative or a gas containing an alkylenediamine derivative into contact with the skin layer to modify the polyamide resin.

The alkylenediamine derivative is preferably one or more compounds selected from the group consisting of a compound represented by the following general formula (1), a compound represented by the following general formula (2), a compound represented by the following general formula (3), a compound represented by the following general formula (4), and polyalkyleneimine and a derivative thereof,

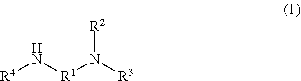

wherein R¹ represents a hydrocarbon group having 1 to 20 carbon atoms, and R², R³, and R⁴ each independently represent hydrogen or a hydrocarbon group having 1 to 20 carbon atoms,

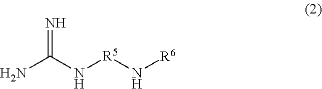

wherein R⁵ represents a hydrocarbon group having 1 to 20 carbon atoms, and R⁶ represents hydrogen or a hydrocarbon group having 1 to 20 carbon atoms,

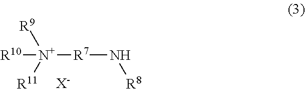

wherein R⁷, R⁹, R¹⁰, and R¹¹ represent a hydrocarbon group having 1 to 20 carbon atoms, R⁹, R¹⁰, and R¹¹ may be bonded to each other to form a ring structure, R⁸ represents hydrogen or a hydrocarbon group having 1 to 20 carbon atoms, and X⁻ represents a counter anion, and

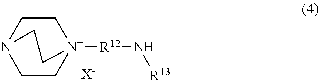

wherein R¹² represents a hydrocarbon group having 1 to 20 carbon atoms, R¹³ represents hydrogen or a hydrocarbon group having 1 to 20 carbon atoms, and X⁻ represents a counter anion.

Since at least the surface of the skin layer of the composite reverse osmosis membrane of the present invention is formed of the modified polyamide resin modified with the alkylenediamine derivative, the composite reverse osmosis membrane is excellent in hydrophilicity and water permeability, and has excellent antifouling properties and/or antibacterial properties.

### BRIEF DESCRIPTION OF THE DRAWINGS

FIG. 1 is a graph showing the results of antifouling experiments using BSA as a model contaminant for composite reverse osmosis membranes produced in Comparative Example 1 and Examples 1 to 3;

FIG. 2 is a graph showing the results of antifouling experiments using SA as a model contaminant for composite reverse osmosis membranes produced in Comparative Example 1 and Examples 1 to 3;

FIG. 3 is a graph showing the results of antifouling experiments using LYZ as a model contaminant for composite reverse osmosis membranes produced in Comparative Example 1 and Examples 1 to 3;

FIG. 4 is a graph showing the results of antifouling experiments using DTAB as a model contaminant for composite reverse osmosis membranes produced in Comparative Example 1 and Examples 1 to 3;

FIG. 5 is a graph showing the results of antifouling experiments using BSA as a model contaminant for composite reverse osmosis membranes produced in Comparative Example 1 and Example 4;

FIG. 6 is a graph showing the results of antifouling experiments using SA as a model contaminant for composite reverse osmosis membranes produced in Comparative Example 1 and Example 4;

FIG. 7 is a graph showing the results of antifouling experiments using LYZ as a model contaminant for composite reverse osmosis membranes produced in Comparative Example 1 and Example 4; and

FIG. 8 is a graph showing the results of antifouling experiments using DTAB as a model contaminant for composite reverse osmosis membranes produced in Comparative Example 1 and Example 4.

### DETAILED DESCRIPTION OF THE PREFERRED EMBODIMENTS

Hereinafter, embodiments of the present invention will be described. A composite reverse osmosis membrane of the present invention includes: a porous support; and a skin layer formed on a surface of the porous support. The skin layer contains a polyamide resin. The polyamide resin is a modified polyamide resin modified with an alkylenediamine derivative.

The polyamide resin is obtained by polymerizing a polyfunctional amine component and a polyfunctional acid halide component.

The polyfunctional amine component is a polyfunctional amine having two or more reactive amine groups. Examples thereof include aromatic, aliphatic, and alicyclic polyfunctional amines.

Examples of the aromatic polyfunctional amines include m-phenylenediamine, p-phenylenediamine, o-phenylenediamine, 1,3,5-triaminobenzene, 1,2,4-triaminobenzene, 3,5-diaminobenzoic acid, 2,4-diaminotoluene, 2,6-diaminotoluene, N,N′-dimethyl-m-phenylenediamine, 2,4-diaminoanisole, amidol, and xylylenediamine.

Examples of the aliphatic polyfunctional amines include ethylenediamine, propylenediamine, tris(2-aminoethyl)amine, and N-phenyl-ethylenediamine.

Examples of the alicyclic polyfunctional amines include 1,3-diaminocyclohexane, 1,2-diaminocyclohexane, 1,4-diaminocyclohexane, piperazine, 2,5-dimethylpiperazine, and 4-aminomethylpiperazine.

These polyfunctional amines may be used singly or in any combination of two or more thereof. In order to obtain a skin layer having high salt-rejection performance, it is preferred to use an aromatic polyfunctional amine.

The polyfunctional acid halide component is a polyfunctional acid halide having two or more reactive carbonyl groups.

Examples of the polyfunctional acid halide include aromatic, aliphatic, and alicyclic polyfunctional acid halides.

Examples of the aromatic polyfunctional acid halides include trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, and chlorosulfonylbenzene dicarboxylic acid dichloride.

Examples of the aliphatic polyfunctional acid halides include propanedicarboxylic acid dichloride, butanedicarboxylic acid dichloride, pentanedicarboxylic acid dichloride, propanetricarboxylic acid trichloride, butanetricarboxylic acid trichloride, pentanetricarboxylic acid trichloride, glutaryl halides, and adipoyl halides.

Examples of the alicyclic polyfunctional acid halides include cyclopropanetricarboxylic acid trichloride, cyclobutanetetracarboxylic acid tetrachloride, cyclopentanetricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, and tetrahydrofurandicarboxylic acid dichloride.

These polyfunctional acid halides may be used singly or in any combination of two or more thereof. In order to obtain a skin layer having high salt-rejection performance, it is preferred to use an aromatic polyfunctional acid halide. It is also preferred to use, as at least one component of the polyfunctional acid halide components, a polyfunctional acid halide having tri or higher polyfunctionalities to form a crosslinked structure.

In order to improve the performance of the skin layer containing a polyamide resin, a polymer such as polyvinyl alcohol, polyvinylpyrrolidone, or polyacrylic acid, and a polyhydric alcohol such as sorbitol or glycerin may be copolymerized.

The porous support that supports the skin layer is not particularly limited as long as the porous support can support the skin layer. Usually, an ultrafiltration membrane having micro pores having an average pore diameter of about 10 to 500 Å is preferably used. Examples of materials for forming the porous support include various materials such as polysulfones; polyarylether sulfones (for example, polyether sulfone); polyimides; and polyvinylidene fluorides. Polysulfones and polyarylether sulfones are particularly preferably used from the viewpoint of being chemically, mechanically, and thermally stable. The thickness of such a porous support is usually about 25 to 125 μm, and preferably about 40 to 75 μm, and is not necessarily limited thereto. The porous support is usually reinforced by backing with a base material such as a woven fabric or a nonwoven fabric.

Methods for forming the skin layer containing the polyamide resin on the surface of the porous support is not particularly limited, and any known methods may be used. Examples thereof include an interfacial condensation method, a phase separation method, and a thin membrane application method. Specifically, the interfacial condensation method is a method in which a skin layer is formed by bringing an aqueous amine solution containing a polyfunctional amine component into contact with an organic solution containing a polyfunctional acid halide component to perform interfacial polymerization, and the skin layer is placed on a porous support, or a method in which a skin layer of a polyamide resin is directly formed on a porous support by the interfacial polymerization on the porous support.

In the present invention, a method is preferable, in which an aqueous solution coating layer obtained from an amine aqueous solution containing a polyfunctional amine component is formed on a porous support, and an organic solution containing a polyfunctional acid halide component is then brought into contact with the aqueous solution coating layer to perform interfacial polymerization, thereby forming a skin layer.

In the interfacial polymerization method, the concentration of the polyfunctional amine component in the aqueous amine solution is not particularly limited, and is preferably 0.1 to 5% by weight, and more preferably 0.5 to 2% by weight. When the concentration of the polyfunctional amine component is less than 0.1% by weight, defects such as pinholes are apt to occur in the skin layer, and the salt-rejection performance of the composite reverse osmosis membrane tends to be deteriorated. Meanwhile, when the concentration of the polyfunctional amine component exceeds 5% by weight, the polyfunctional amine component is apt to permeate into the porous support, or the membrane tends to be too thick, which causes increased permeation resistance to cause a decreased permeation flux.

The concentration of the polyfunctional acid halide component in the organic solution is not particularly limited, and is preferably 0.01 to 5% by weight, and more preferably 0.05 to 3% by weight. When the concentration of the polyfunctional acid halide component is less than 0.01% by weight, the unreacted polyfunctional amine component is apt to remain, or defects such as pinholes are apt to occur in the skin layer, which tends to cause deteriorated salt-rejection performance of the composite reverse osmosis membrane. Meanwhile, when the concentration of the polyfunctional acid halide component exceeds 5% by weight, the unreacted polyfunctional acid halide component is apt to remain, or the membrane tends to be too thick, which causes increased permeation resistance to cause a decreased permeation flux.

An organic solution used in the organic solution is not particularly limited as long as the organic solution has low solubility in water, does not deteriorate the porous support, and dissolves the polyfunctional acid halide component, and examples thereof include saturated hydrocarbons such as cyclohexane, heptane, octane and nonane, and halogen-substituted hydrocarbons such as 1,1,2-trichlorotrifluoroethane. The organic solution is preferably a saturated hydrocarbon or a naphthenic solvent having a boiling point of 300° C. or lower, and more preferably 200° C. or lower. These organic solutions may be used alone, or as a mixed solvent of two or more kinds of solvents.

Various additives can be added to the aqueous amine solution or the organic solution for the purpose of facilitating membrane formation and improving the performance of the composite reverse osmosis membrane to be obtained. Examples of the additives include surfactants such as sodium dodecylbenzene sulfonate, sodium dodecyl sulfate, and sodium lauryl sulfate, basic compounds such as sodium hydroxide, trisodium phosphate, and triethylamine that remove hydrogen halide generated by polymerization, and acylation catalysts.

In the present invention, after the skin layer is formed on the surface of the porous support (however, the skin layer may not be completely formed, and may be in the middle of formation), a solution containing an alkylenediamine derivative or a gas containing an alkylenediamine derivative is brought into contact with the skin layer to modify at least the polyamide resin on the surface of the skin layer into a modified polyamide resin. Specifically, the alkylenediamine derivative is reacted with an acyl halide group remaining in the polyamide resin forming the skin layer to introduce an organic group derived from the alkylenediamine derivative into the polyamide resin via a newly formed amide bond.

The alkylenediamine derivative is not particularly limited, and is preferably one or more compounds selected from the group consisting of a compound represented by the following general formula (1), a compound represented by the following general formula (2), a compound represented by the following general formula (3), a compound represented by the following general formula (4), and polyalkyleneimine and a derivative thereof.

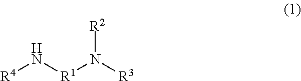

(In the formula, R¹ represents a hydrocarbon group having 1 to 20 carbon atoms, and R², R³, and R⁴ each independently represent hydrogen or a hydrocarbon group having 1 to 20 carbon atoms.)

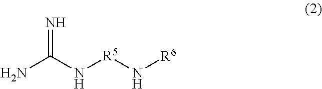

(In the formula, R⁵ represents a hydrocarbon group having 1 to 20 carbon atoms, and R⁶ represents hydrogen or a hydrocarbon group having 1 to 20 carbon atoms.)

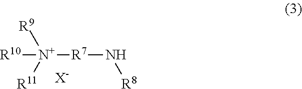

(In the formula, R⁷, R⁹, R¹⁰, and R¹¹ represent a hydrocarbon group having 1 to 20 carbon atoms, R⁹, R¹⁰, and R¹¹ may be bonded to each other to form a ring structure, R⁸ represents hydrogen or a hydrocarbon group having 1 to 20 carbon atoms, and X⁻ represents a counter anion.)

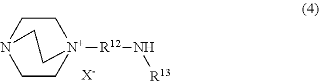

(In the formula, R¹² represents a hydrocarbon group having 1 to 20 carbon atoms, R¹³ represents hydrogen or a hydrocarbon group having 1 to 20 carbon atoms, and X⁻ represents a counter anion.)

Examples of the hydrocarbon group include a linear or branched aliphatic saturated or unsaturated hydrocarbon group, an alicyclic saturated or unsaturated hydrocarbon group (including a cross-linking ring or a fused ring), an aromatic hydrocarbon group, and an organic group in which two or more kinds thereof are bonded. The hydrocarbon group may have various substituents. The number of carbon atoms of the substituent is not included in the number of carbon atoms of the hydrocarbon group.

The numbers of carbon atoms in the hydrocarbon groups are each independently 1 to 20, preferably 1 to 15, more preferably 1 to 10, still more preferably 1 to 5, yet still more preferably 1 to 3, and particularly preferably 1 or 2.

The X⁻ represents a counter anion, and examples thereof include a halogen anion, ClO₄⁻, BF₄⁻, PF₆⁻, CH₃COO⁻, and CH₃ (C₆H₄) SO₃.

The compound represented by the general formula (1), the compound represented by the general formula (2), and the compound represented by the general formula (4) are each preferably the following compounds.

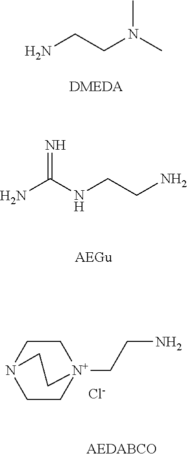

Examples of the polyalkyleneimine and the derivative thereof include polymers obtained by polymerizing one or two or more of alkyleneimines having 2 to 8 carbon atoms, and preferably alkyleneimines having 2 to 4 carbon atoms, such as ethyleneimine, propyleneimine, butyleneimine, dimethylethyleneimine, pentyleneimine, hexyleneimine, heptyleneimine, and octyleneimine by a conventional method, and modified polymers obtained by reacting these polymers with various compounds to chemically modify the polymers. The polyalkyleneimine may be linear or branched.

The polyalkyleneimine is preferably polyethyleneiminea. The polyalkyleneimine derivative is preferably modified polyethyleneimine in which a carboxyalkyl group (the number of carbon atoms in an alkyl group is preferably 1 to 10, and more preferably 1 to 5) is added to a nitrogen atom of polyethyleneimine, and more preferably the following modified polyethyleneimine.

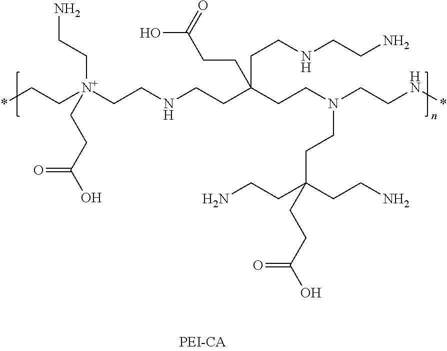

The weight average molecular weight of the polyalkyleneimine and the derivative thereof is preferably 800 to 250000, more preferably 1800 to 70000, still more preferably 3000 to 50000, yet still more preferably 5000 to 30000, and particularly preferably 5000 to 20000 from the viewpoint of improving water permeability and antifouling performance.

Methods for bringing the solution (aqueous solution or organic solution) containing the alkylenediamine derivative into contact with the skin layer are not particularly limited, and examples thereof include a method in which the solution is applied onto the skin layer and a method in which the skin layer is immersed in the solution.

Methods for bringing the gas containing the alkylenediamine derivative into contact with the skin layer are not particularly limited, and examples thereof include a method in which the gas is blown onto the skin layer, and a method in which the skin layer is exposed to the gas atmosphere.

The concentration of the alkylenediamine derivative in the solution or the gas is not particularly limited, and is appropriately adjusted.

The thickness of the skin layer formed on the porous support is not particularly limited, and is usually about 0.05 to 2 μm, and preferably 0.1 to 1 μm.

The composite reverse osmosis membrane of the present invention is not limited in its shape at all. That is, any conceivable membrane shape such as a flat membrane shape or a spiral element shape is possible. Conventionally known various treatments may be applied to the composite reverse osmosis membrane in order to improve its salt-rejection property, water permeability, and oxidation resistance and the like.

### EXAMPLES

Hereinafter, the present invention will be described with reference to Examples, but the present invention is not limited to these Examples.

### Comparative Example 1

An aqueous amine solution containing 1.1% by mass of triethylamine, 2.4% by mass of camphorsulfonic acid, and 2.0% by mass of m-phenylenediamine was applied onto a porous polysulfone supporting membrane. After 2 minutes, an excess aqueous amine solution was removed to form an aqueous solution coating layer. Next, a hexane solution containing 0.16% by mass of trimesic acid chloride was applied onto the surface of the aqueous solution coating layer. After 1 minute, an excess hexane solution was removed. Hexane was then evaporated in the air for 2 minutes, followed by holding in a hot air dryer at 60° C. for 10 minutes to form a skin layer containing a polyamide resin on the porous polysulfone supporting membrane, thereby preparing a composite reverse osmosis membrane.

### Example 1

An aqueous amine solution containing 1.1% by mass of triethylamine, 2.4% by mass of camphorsulfonic acid, and 2.0% by mass of m-phenylenediamine was applied onto a porous polysulfone supporting membrane. After 2 minutes, an excess aqueous amine solution was removed to form an aqueous solution coating layer. Next, a hexane solution containing 0.16% by mass of trimesic acid chloride was applied onto the surface of the aqueous solution coating layer. After 1 minute, an excess hexane solution was removed. Hexane was then evaporated in the air for 2 minutes to form a skin layer containing a polyamide resin. Then, an aqueous solution containing 0.5% by mass of the aforementioned DMEDA as an alkylenediamine derivative was applied onto the surface of the skin layer, followed by holding under an atmosphere of 25° C. and a humidity of 40% RH for 2 minutes, and holding in a hot air dryer at 60° C. for 10 minutes to modify the polyamide resin forming the skin layer. Thereby, a composite reverse osmosis membrane including the skin layer containing the modified polyamide resin on the porous polysulfone supporting membrane was prepared.

### Example 2

A composite reverse osmosis membrane was prepared by the same method as in Example 1 except that an aqueous solution containing 1.9% by mass of the aforementioned AEGu was used in place of the aqueous solution containing 0.5% by mass of DMEDA.

### Example 3

A composite reverse osmosis membrane was prepared by the same method as in Example 1 except that an aqueous solution containing 0.6% by mass of the aforementioned AEDABCO was used in place of the aqueous solution containing 0.5% by mass of DMEDA.

### Example 4

A composite reverse osmosis membrane was prepared by the same method as in Example 1 except that an aqueous solution containing 0.5% by mass of the aforementioned PEI-CA was used in place of the aqueous solution containing 0.5% by mass of DMEDA.

### [Evaluation and Measuring Method]

### (Measurement of Permeation Flux and Salt-Rejection Rate)

The permeation flux (Flux) and salt rejection rate (Rejection) of each of the composite reverse osmosis membranes prepared in Comparative Example 1 and Examples 1 to 4 were measured using a reverse osmosis cross flow test system (effective membrane surface area: 28.26 cm²). The reverse osmosis cross flow test system was first operated at a pressure of 20 bar for 2 hours to stabilize the permeability of the composite reverse osmosis membrane. Next, the reverse osmosis cross flow test system was operated at a pressure of 15 bar for 1 hour using an aqueous feed solution containing NaCl having a concentration of 2000 mg/L, and the permeation flux of the composite reverse osmosis membrane was then measured (a permeation liquid was collected for 30 minutes). The permeation flux was determined by the following formula (1). The concentrations of the feed liquid and the permeation liquid were measured using a conductivity meter (Thermo, Eutech CON2700, USA). The salt rejection rate was determined by the following formula (2). The test was repeated three times, and the average data thereof was used as a final result. The final result was as follows.

J=V/(A*ΔP*Δt) (1)

J: Permeation flux (Lm⁻² h⁻¹ bar⁻¹, LMH/bar)

V: Volume of permeation liquid (L)

A: Effective membrane surface area of composite reverse osmosis membrane (28.26 cm²)

Δt: Permeation time (h)

ΔP: Penetration pressure (bar)

$$R = ( 1 - \frac{{C}_{P}}{{C}_{f}} ) \times 100 \% \qquad ( 2 )$$

R: Salt rejection rate (%)

C_{f}: Concentration of feed liquid (mg/L)

Cₚ: Concentration of permeation liquid (mg/L)

Comparative Example 1: Permeation flux: 2.42 Lm⁻² h⁻¹ bar⁻¹, Salt rejection rate: 99.65%

Example 1: Permeation flux: 4.05 Lm⁻² h⁻¹ bar⁻¹, Salt rejection rate: 98.53%

Example 2: Permeation flux: 3.26 Lm⁻² h⁻¹ bar⁻¹, Salt rejection rate: 98.74%

Example 3: Permeation flux: 4.28 Lm⁻² h⁻¹ bar⁻¹, Salt rejection rate: 98.53%

Example 4: Permeation flux: 3.92 Lm⁻² h⁻¹ bar⁻¹, Salt rejection rate: 98.93%

### (Evaluation of Antifouling)

As model contaminants, albumin from bovine serum (BSA), sodium alginate (SA), lysozyme (LYZ), and dodecyl trimethyl ammonium bromide (DTAB) were used. The BSA and the LYZ were employed as an example of organic polymer (protein molecule) contaminants each having a negative charge and a positive charge. The SA was employed as an example of natural biomass contaminants. The DTAB was employed as an example of small molecule contaminants as a surfactant having a positive charge. These are typical representative examples of three most common organic contaminants in a water system.

An antifouling experiment was performed in the following four stages.

In the first stage, an RO system was operated at 15 bar at a cross-flow rate of 14 cm/s for 30 minutes to determine a baseline permeation flux and a salt-rejection rate using an aqueous feed solution containing 2000 mg/L NaCl.

In the second stage, 200 ppm of the model contaminant was added to the aqueous feed solution, and the RO system was operated for 6 hours under the same conditions as in the first stage.

In the third stage, the composite reverse osmosis membrane was washed using deionized water at a circulation flow rate of 3 L/min for 30 minutes.

In the fourth stage, the permeation flux was measured again using an aqueous feed solution containing 2000 mg/L NaCl.

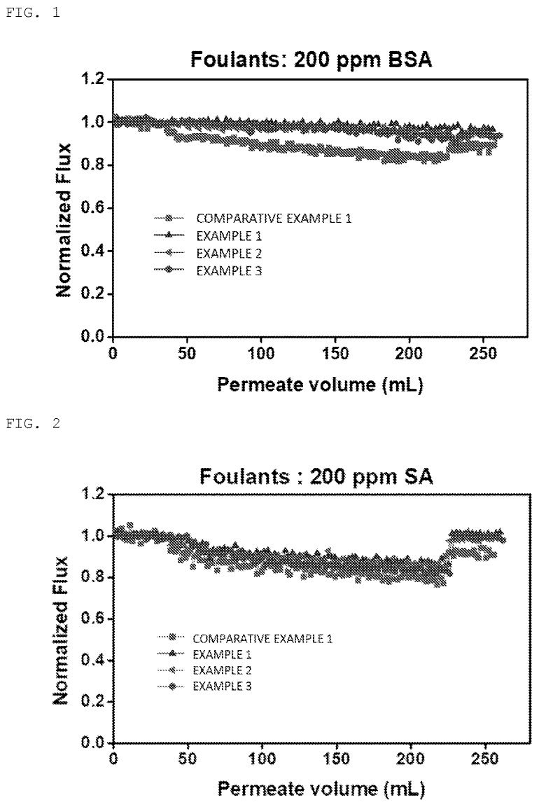

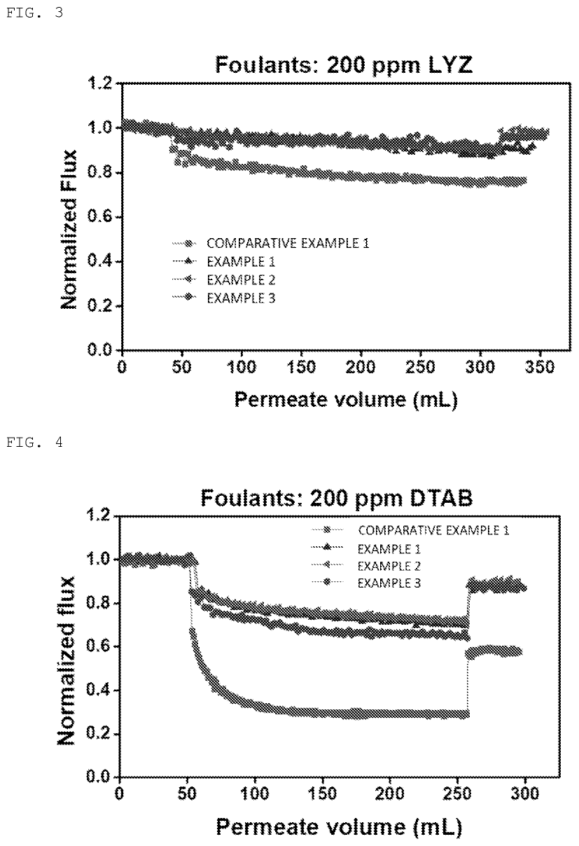

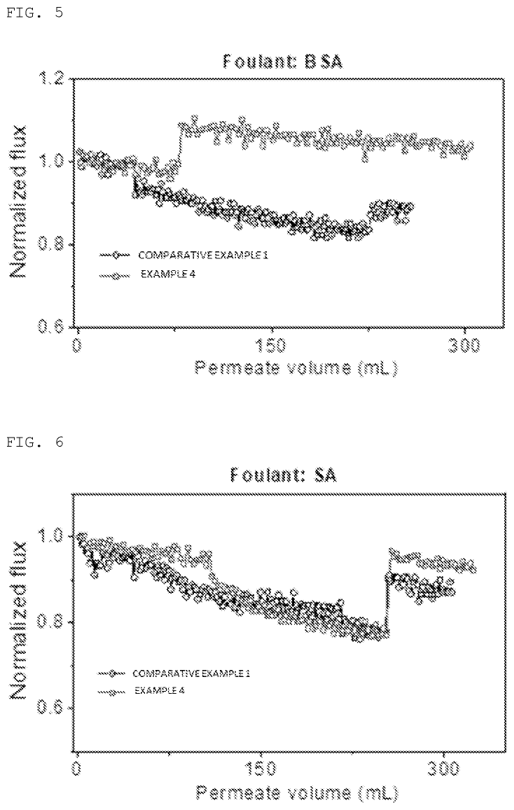

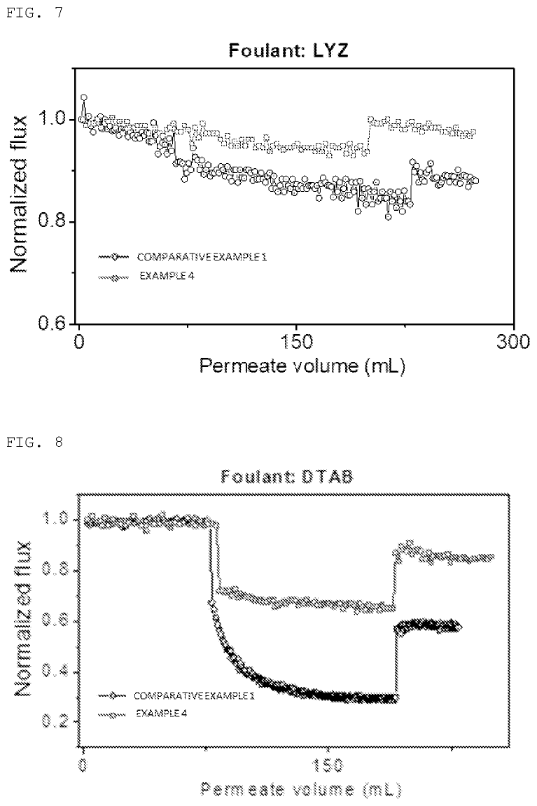

As shown in graphs of FIGS. 1 to 8, it can be seen that the composite reverse osmosis membranes of Examples 1 to 4 are more excellent in antifouling characteristics than those of the composite reverse osmosis membrane of Comparative Example 1.

### INDUSTRIAL APPLICABILITY

The composite reverse osmosis membrane of the present invention is suitable for production of ultrapure water, and desalination of brine or sea water, and the like, and can remove and recover pollution sources or effective substances from contamination or the like which causes pollution such as dyeing wastewater or electrodeposition coating material wastewater to contribute to closing of the wastewater. The composite reverse osmosis membrane can be used for advanced treatments such as concentration of active ingredients in food applications and the like, and removal of harmful ingredients in water purification and sewage applications and the like. The composite reverse osmosis membrane can be used for wastewater treatment in oil fields and shale gas fields and the like.

1. A composite reverse osmosis membrane comprising:
a porous support; and
a skin layer formed on a surface of the porous support, the skin layer containing a polyamide resin,
wherein the polyamide resin is a modified polyamide resin modified with an alkylenediamine derivative.

2. The composite reverse osmosis membrane according to claim 1, wherein the alkylenediamine derivative is one or more compounds selected from the group consisting of a compound represented by the following general formula (1), a compound represented by the following general formula (2), a compound represented by the following general formula (3), a compound represented by the following general formula (4), and polyalkyleneimine and a derivative thereof, 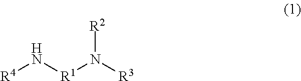
wherein R¹ represents a hydrocarbon group having 1 to 20 carbon atoms, and R², R³, and R⁴ each independently represent hydrogen or a hydrocarbon group having 1 to 20 carbon atoms, 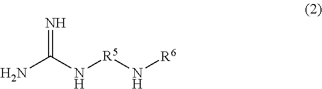
wherein R⁵ represents a hydrocarbon group having 1 to 20 carbon atoms, and R⁶ represents hydrogen or a hydrocarbon group having 1 to 20 carbon atoms, 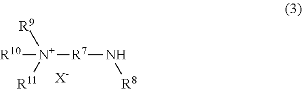
wherein R⁷, R⁹, R¹⁰, and R¹¹ represent a hydrocarbon group having 1 to 20 carbon atoms, R⁹, R¹⁰, and RH may be bonded to each other to form a ring structure, R⁸ represents hydrogen or a hydrocarbon group having 1 to 20 carbon atoms, and X⁻ represents a counter anion, and 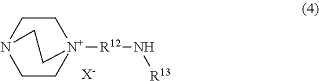
wherein R¹² represents a hydrocarbon group having 1 to 20 carbon atoms, R¹³ represents hydrogen or a hydrocarbon group having 1 to 20 carbon atoms, and X⁻ represents a counter anion.

3. A method for producing a composite reverse osmosis membrane, the method comprising:
bringing an aqueous solution containing a polyfunctional amine component into contact with an organic solution containing a polyfunctional acid halide component on a porous support to form a skin layer containing a polyamide resin on a surface of the porous support; and
bringing a solution containing an alkylenediamine derivative or a gas containing an alkylenediamine derivative into contact with the skin layer to modify the polyamide resin.

4. The method for producing a composite reverse osmosis membrane according to claim 3, wherein the alkylenediamine derivative is one or more compounds selected from the group consisting of a compound represented by the following general formula (1), a compound represented by the following general formula (2), a compound represented by the following general formula (3), a compound represented by the following general formula (4), and polyalkyleneimine and a derivative thereof, 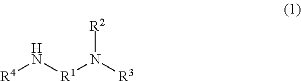
wherein R¹ represents a hydrocarbon group having 1 to 20 carbon atoms, and R², R³, and R⁴ each independently represent hydrogen or a hydrocarbon group having 1 to 20 carbon atoms, 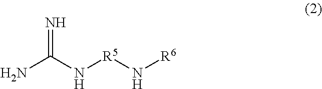
wherein R⁵ represents a hydrocarbon group having 1 to 20 carbon atoms, and R⁶ represents hydrogen or a hydrocarbon group having 1 to 20 carbon atoms, 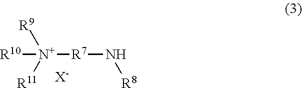
wherein R⁷, R⁹, R¹⁰, and R¹¹ represent a hydrocarbon group having 1 to 20 carbon atoms, R⁹, R¹⁰, and R¹¹ may be bonded to each other to form a ring structure, R⁸ represents hydrogen or a hydrocarbon group having 1 to 20 carbon atoms, and X⁻ represents a counter anion, and 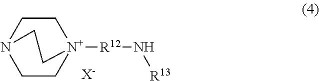
wherein R¹² represents a hydrocarbon group having 1 to 20 carbon atoms, R¹³ represents hydrogen or a hydrocarbon group having 1 to 20 carbon atoms, and X⁻ represents a counter anion.
